(19) United States
(12) Patent Application Publication
(10) Pub. No.: US 2010/0310821 A1
(43) Pub. Date: Dec. 9, 2010

(54) Repair strip for utensil baskets in dishwashers

(76) Inventor: Robert Joseph Del Sole, Larchmont, NY (US)

Correspondence Address: ROBERT J. DEL SOLE, 86 VALLEY ROAD, LARCHMONT, NY, 10538, US

(21) Appl. No.: 12/802,345

(22) Filed: Jun. 4, 2010

Related U.S. Application Data
(60) Provisional application No. 61/217,779, filed on Jun. 5, 2009.

(51) Int. Cl. B32B 3/10

(52) U.S. Cl. 428/131

(57) ABSTRACT

A utensil basket used in dishwashers which has compartments to hold utensils for washing and a base in those compartments where the utensils rest on and allow detergent to drain out during washing and rinsing cycles.

This invention is repair for the bottom of the utensils baskets where the utensils rest when the basket has worn away from use and can no longer hold the utensils in place.

### CROSS-REFERENCE TO RELATED APPLICATIONS

This application is a continuation in part of Ser. No. 61/217/779 filed Jun. 6, 2009

### STATEMENT REGARDING FEDERALLY SPONSORED RESAEACH OR DEVELOPMENT

Research and development of the present invention and application have not been Federally sponsored, and no rights are given under any Federal program.

### REFERENCE TO A MICROFICHE APPENDIX

Not applicable

### BACKGROUND-FIELD OF INVENTION

This invention relates to means of repairing the utensil basket of a dishwasher which holds knives, forks, spoons and small items.

### DESCRIPTION OF THE RELATED ART INCLUDING INFORMATION DISCLOSED UNDER 37 CFR 1.97-1.98

The present invention utilizes a piece of plastic material, suitable for dishwasher use, to repair worn and broken parts of the utensil basket in dishwashers. These baskets are made of a plastic or similar type material and hold knives, forks, spoons and other small utensils for washing. Sharp edges on knives and forks in particular and the constant movement caused by the washing process causes the baskets to wear out prematurely compared to the dishwasher as a whole. Once these baskets are worn through on the bottom of the basket they can no longer hold the utensils in place. In accordance with the present invention a plastic strip made of dishwasher safe material with perforated holes to allow the detergent to drain through the basket that can be cut to fit the worn area of the basket and inserted to fill the void where the original basket has worn out.

### SUMMARY OF THE INVENTION

This present invention provides a cost effective means of repairing the utensil basket in a dishwasher. The utensil basket is primarily used for knives, forks, spoons and small items to be washed. If these small items fall through the basket they can cause a number of problems. The tray used for dishes can get jammed, the small utensils can wind up damaging the finish inside the dishwasher if they lodge halfway through the dish tray when it is pulled out, or may wind up on the bottom of the dishwasher on the heating element, used for high heat cycles. The repair strip is made of a dishwasher safe material with perforated holes in assorted colors that can be cut to conform to different shape compartments of the utensil basket to make the necessary repair. Replacement baskets are not always available for older model dish washers, this invention would allow a cost effective means of repair.

### BRIEF DESDRIPTION OF THE DRAWINGS

The above and other objects and advantages of this invention may be more clearly seen when viewed in conjunction with the accompanying drawings wherein:

FIG. 1 shows a view of a typical utensil basket used in a dishwasher;

FIG. 2 shows a cut away view of a utensil basket where the utensils have worn holes in the base from typical use;

FIG. 3 shows a repair to the basket utilizing the repair strip material with the perforated holes;

FIG. 4 shows a view of the repair strip with the perforated holes cut to size;

FIG. 5 shows a view of repair strip with the perforated holes that can be cut to fit specific needs.

### DETAILED DESCRIPTION OF THE INVENTION

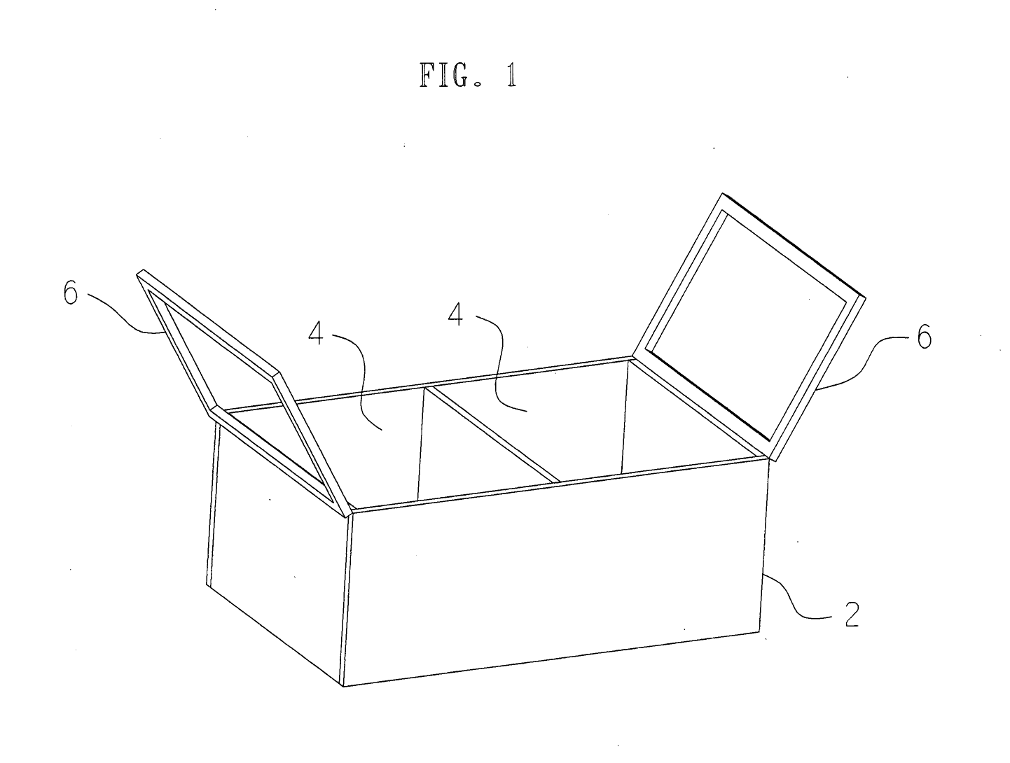

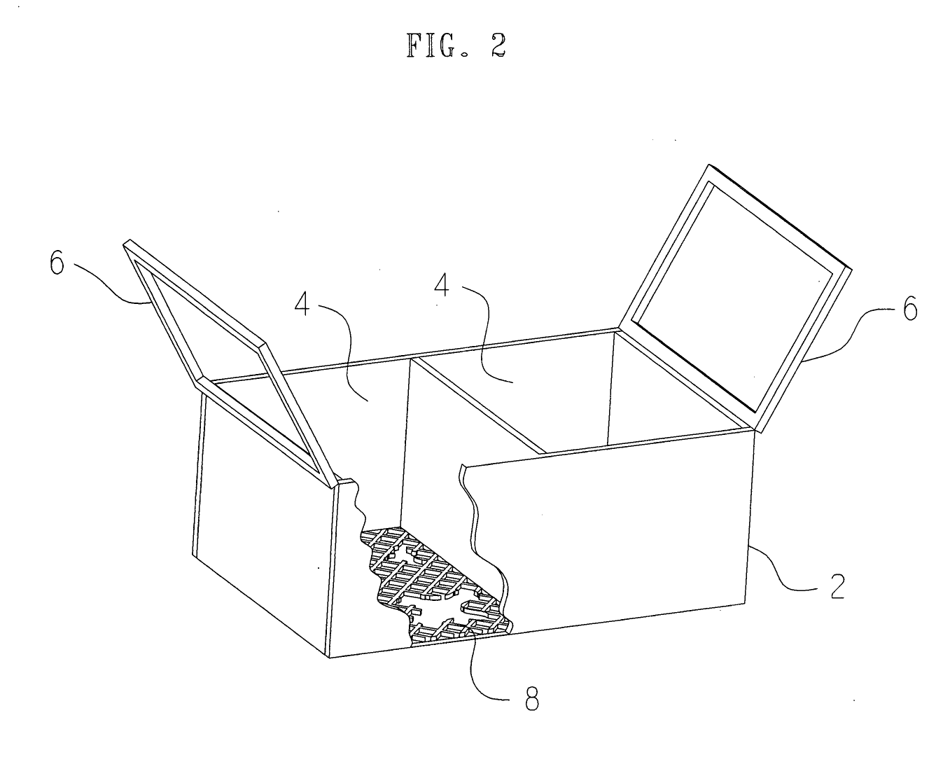

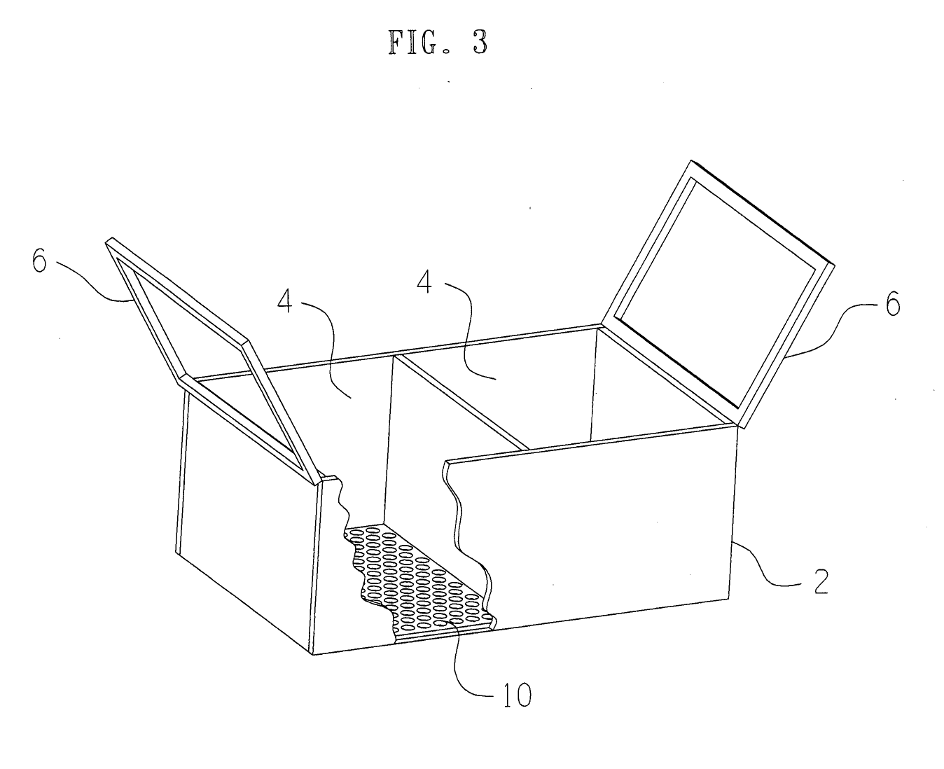

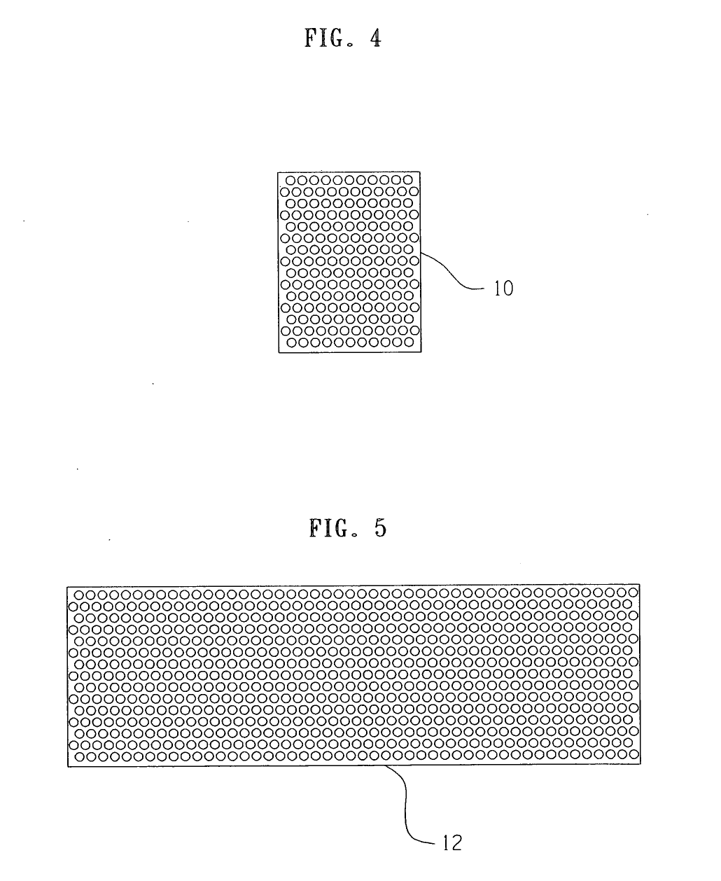

Referring now to FIG. 1 of the drawing which shows a typical utensil basket comprised of a main body 2, two lifting handles 6 and two compartments 4, which hold the utensils for washing. FIG. 2 shows a cutaway view of the utensil basket main body 2, with the lifting handles 6, the compartments for the utensils 4 and a section of the base 8 of the basket main body 2 which wears away from use. FIG. 3 is a cutaway view of the utensil basket main body 2, with the lifting handles 6, the compartment for the utensils 4 with the present invention repair strip with perforated holes 10 in place on the base 8 of the compartment 4. FIG. 4 is a view of the present invention repair strip with the perforated holes 10 cut to size for a particular repair. FIG. 5 is a view of the present invention repair strip with the perforated holes 12 which can be cut to any desired shape to make a repair to a utensil basket.

While the invention has been explained by a detailed description of certain specific embodiments, it is understood that various modifications and substitutions can be made in any of them within the scope of the appended claims, which are intended also to include equivalents of such embodiments.

What is claimed is:

1. A repair strip with perforated holes which allows detergent to drain through the basket and can be used to repair damaged utensil baskets used in dishwashers:

2. The closure of claim 1 wherein the repair strip is made of dishwasher safe material.

3. The closure of claim 1 wherein the repair strip contains perforated holes.

4. The closure of claim 1 wherein the repair strip can be shaped to any size.

5. The closure of claim 1 wherein the repair strip can be of various colors.

6. The closure of claim 1 wherein the repair strip can be replaced as it wears.
